(19) United States
(12) Patent Application Publication
(10) Pub. No.: US 2007/0195417 A1
(43) Pub. Date: Aug. 23, 2007

(54) Light-absorbing member

(76) Inventors: Yoshiharu Yamamoto, Osaka (JP); Motonobu Yoshikawa, Osaka (JP); Daizaburo Matsuki, Osaka (JP); Yoshimasa Fushimi, Osaka (JP)

Correspondence Address: MCDERMOTT WILL & EMERY LLP, 600 13TH STREET, NW, WASHINGTON, DC, 20005-3096, US

(21) Appl. No.: 10/592,493

(22) PCT Filed: Mar. 10, 2005
(86) PCT No.: PCT/JP05/04741

§ 371 Date: Sep. 12, 2006

(30) Foreign Application Priority Data
Mar. 12, 2004 (JP) 2004-071409

(51) Int. Cl. G02B 5/28

(52) U.S. Cl. 359/590

(57) ABSTRACT

An object of the present invention is to provide a light-absorbing member capable of preventing the reflection of light at the interface with air and absorbing the light substantially completely. A light-absorbing member has a substrate (101) made of a material capable of absorbing light of which reflection is to be prevented, and an antireflective structure (102) including structural elements, the structural elements forming an array with a period shorter than the wavelength of the light.

### TECHNICAL FIELD

The present invention relates to a light-absorbing member, more particularly, to a light-absorbing member capable of efficiently absorbing unnecessary light in optical apparatuses, such as projection display devices and image-taking devices.

### BACKGROUND ART

In an optical apparatus, the handling of unnecessary light inside the apparatus is important. Herein, unnecessary light is defined as light propagated along unintended light paths inside the optical apparatus and not used to achieve the intrinsic functions of the optical system. Such unnecessary light frequently causes degradation in the performance of the optical apparatus.

As a method for obtaining a large-screen image, for example, a projection image display device is known wherein an optical image corresponding to an image signal is formed on a light valve and the optical image is magnified and projected on a screen by a projection lens. As an example of this kind of projection image display device, a device using a reflective light valve is available wherein an optical image is formed by controlling the traveling direction of illumination light in accordance with an image signal. Such a projection image display device using a reflective light valve has high light utilization efficiency and can display projection images having high luminance.

In a projection display device using a reflective light valve, illumination light components not entering its projection lens become unnecessary light that is the so-called OFF light. However, if no countermeasures are taken, the OFF light is reflected by prisms disposed around the light valve, mechanical parts for holding various optical elements, etc. and eventually enters the projection lens. If the OFF light eventually enters the projection lens, the quality of an image to be displayed on the screen is degraded significantly. Hence, in this kind of projection display device, an absorbing plate coated with black paint has been used conventionally to absorb the OFF light (for example, refer to Japanese Laid-open Patent Publication No. 2001-66693).

In addition, as another example, a countermeasure for unnecessary light in the above-mentioned projection lens and the lens barrel for holding the image-taking optical system being used in optical apparatuses, such as digital still cameras and camcorders, has been known conventionally. Generally, the light reflected between the faces of the lenses inside a lens barrel and the light reflected by the mechanical parts for holding various optical elements become unnecessary light referred to as stray light. The stray light may occasionally return to the light path of the optical system along complicated reflection light paths. In the cases of the above-mentioned projection lens and an imaging optical system, such as the image-taking optical system of a digital still camera or the like, the stray light causes ghost or flare in the optical system, thereby causing degradation in the image quality of an image to be formed. Hence, in a conventional lens barrel, the internal face of the barrel is made of a black material or matte finished to prevent generation of stray light.

### DISCLOSURE OF THE INVENTION

However, in the case of using the absorbing plate coated with black paint, as in the example of the projection display device described in Japanese Laid-open Patent Publication No. 2001-66693, the surface of the absorbing plate becomes an interface with air, thereby causing a problem of allowing OFF light to be reflected at an unignorable rate and to return to the light path. Furthermore, as in the example of the lens barrel, even if the internal face of the lens barrel is made of a black material or matte finished, it is also difficult to completely prevent stray light.

An object of the present invention is to provide a light-absorbing member capable of preventing the reflection of light at the interface with air and absorbing the light substantially completely.

The above-mentioned object is achieved by a light-absorbing member has a substrate made of a material capable of absorbing light of which reflection is to be prevented, and an antireflective structure including structural elements, the structural elements forming an array with a period shorter than the wavelength of the light.

The present invention can provide a light-absorbing member capable of preventing the reflection of light at the interface with air and absorbing the light substantially completely.

In this description, the antireflection structure is defined as a member having structural elements formed on its surface to prevent the reflection of light, and includes not only an aspect of completely preventing the reflection of the light whose reflection should be prevented but also an aspect of having an effect of reducing the reflection of light which has a predetermined wavelength and whose reflection should be reduced.

### BRIEF DESCRIPTION OF THE DRAWINGS

FIG. 1 is a schematic cross-sectional view showing a light-absorbing member in accordance with a first embodiment of the present invention;

FIG. 2 is a magnified schematic perspective view showing the light-absorbing member in accordance with the first embodiment of the present invention;

FIG. 3 is a schematic cross-sectional view showing another example of the light-absorbing member in accordance with the first embodiment of the present invention;

FIG. 4 is a schematic cross-sectional view showing another example of the antireflection structure of the light-absorbing member in accordance with the first embodiment of the present invention;

FIG. 5 is a schematic cross-sectional view showing a light-absorbing member in accordance with a second embodiment of the present invention;

FIG. 6 is a magnified schematic perspective view showing the light-absorbing member in accordance with the second embodiment of the present invention;

FIG. 7 is a schematic cross-sectional view showing another example of the light-absorbing member in accordance with the second embodiment of the present invention;

FIG. 8 is a schematic view showing a light-absorbing device in accordance with a third embodiment of the present invention;

FIG. 9 is a schematic cross-sectional view showing an illumination prism device in accordance with a fourth embodiment of the present invention;

FIG. 10 is a schematic cross-sectional view showing another example of the illumination prism device in accordance with the fourth embodiment of the present invention;

FIG. 11 is a schematic configurational view showing a projection display device in accordance with a fifth embodiment of the present invention;

FIG. 12A is a schematic configurational view showing a projection display device in accordance with a sixth embodiment of the present invention,

FIG. 12B is a elevation view showing a color wheel provided for a projection display device in accordance with a sixth embodiment of the present invention;

FIG. 13 is a schematic configurational view showing a rear projector in accordance with a seventh embodiment of the present invention;

FIG. 14 is a schematic configurational view showing a multivision system in accordance with an eighth embodiment of the present invention;

FIG. 15 is a schematic cross-sectional view showing a lens barrel in accordance with a ninth embodiment of the present invention;

FIG. 16 is a schematic perspective view showing a method for producing the lens barrel in accordance with the ninth embodiment of the present invention;

FIG. 17 is a schematic cross-sectional view showing a lens barrel in accordance with a tenth embodiment of the present invention;

FIG. 18 is a schematic cross-sectional view showing a lens barrel in accordance with an eleventh embodiment of the present invention; and

FIG. 19 is a magnified schematic perspective view showing a sheet to be inserted on the internal face side of the lens barrel in accordance with the eleventh embodiment of the present invention.

### BEST MODE FOR CARRYING OUT THE INVENTION

### FIRST EMBODIMENT

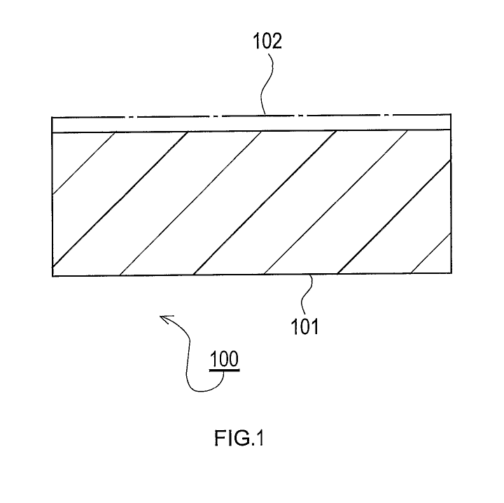

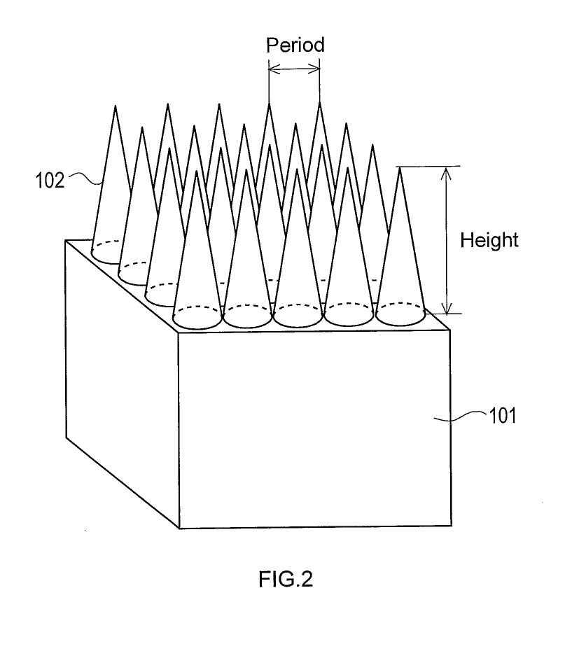

FIG. 1 is a schematic cross-sectional view showing a light-absorbing member in accordance with a first embodiment of the present invention, and FIG. 2 is a schematic perspective view showing the magnification thereof. As shown in FIGS. 1 and 2, the light-absorbing member 100 in accordance with this embodiment comprises a substrate 101 and an antireflection structure 102. When light whose reflection should be prevented enters as a luminous flux, the substrate 101 has a size enclosing the luminous flux and also has mechanical strength and a thickness required in structure. In addition, the substrate 101 is made of a material capable of absorbing light whose reflection should be reduced; for example, it is made of a black material when the light whose reflection should be prevented is visible light. The black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin.

In the antireflection structure 102, a cone of 0.15 μm in height is used as a structural element, and these cones are disposed on the surface of the substrate 101 in an array form at a period of 0.15 μm. The period between the cones herein corresponds to a period shorter than the wavelength of the visible spectrum (400 nm to 700 nm). In addition, the height of these cones corresponds to the period or more. Since the antireflection structure 102 of the light-absorbing member 100 has the above-mentioned configuration, even if light having a wavelength of the visible spectrum or longer enters, the light is not reflected but can be absorbed by the substrate 101 substantially completely.

An example of a method for producing the light-absorbing member 100 will be described. For example, a pattern is drawn on a quartz glass substrate or the like by an electronic beam drawing method or the like and subjected to dry etching or other processing, and a high-precision master mold precision-machined so as to have the same shape as that of the antireflection structure 102 is made beforehand. A glass material heated and softened is subjected to pressure molding using this master mold, whereby a mold for molding antireflection structures is formed of glass. When the substrate 101 made of a black resin material is produced by pressure molding using this mold for molding antireflection structures, the light-absorbing member 100 can be produced at low cost in large quantity.

Since the light-absorbing member 100 in accordance with this embodiment is made by providing the microscopic antireflection structure 102 formed at a period shorter than the wavelength of the light whose reflection should be prevented on the surface of the substrate 101 as described above, the reflection of light at the interface with air can be prevented and incident light can be absorbed substantially completely by using this light-absorbing member 100.

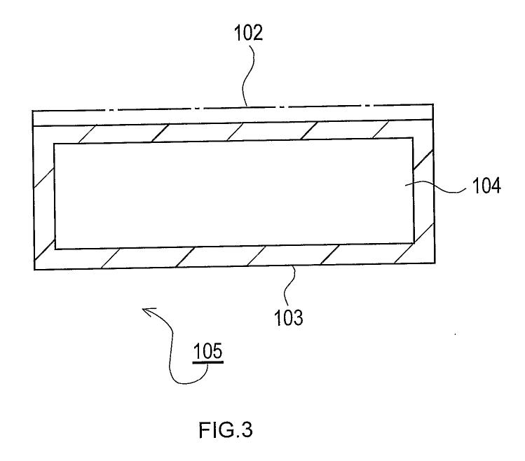

However, if the light-absorbing member 100 is used continuously for a long time at a place at which light arrives frequently, it is heated and may be degraded. In this case, such a problem can be solved by adopting a light-absorbing member 105 having a space 104, in which a refrigerant is sealed, inside the substrate 103 thereof as shown in FIG. 3. As the refrigerant, an antifreeze liquid consisting of polyethylene glycol and water, air, a mixture liquid of alcohol and water, etc. can be used.

In this embodiment, an antireflection structure having cones with a height corresponding to the period or more is formed; however, light-absorbing efficiency can be raised further by forming an antireflection structure having cones with a height corresponding to three times the period or more.

In addition, in this embodiment, visible light is used as the light whose reflection should be reduced; however, other than visible light, ultraviolet light (the wavelength of ultraviolet spectrum: 70 nm to 400 nm), near-infrared light (the wavelength of near-infrared spectrum: 700 nm to 2 μm) and far-infrared light (the wavelength of far-infrared spectrum: 2 μm to 13 μm) can also be used; even in this case, the antireflection structure is formed at a period shorter than the respective wavelengths. Even in this case, the concave portion is desired to have a height corresponding to the period or more or three times the period or more.

Furthermore, in this embodiment, the substrate 101 made of a black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin; however, the substrate can also be obtained by including a pigment, such as carbon black.

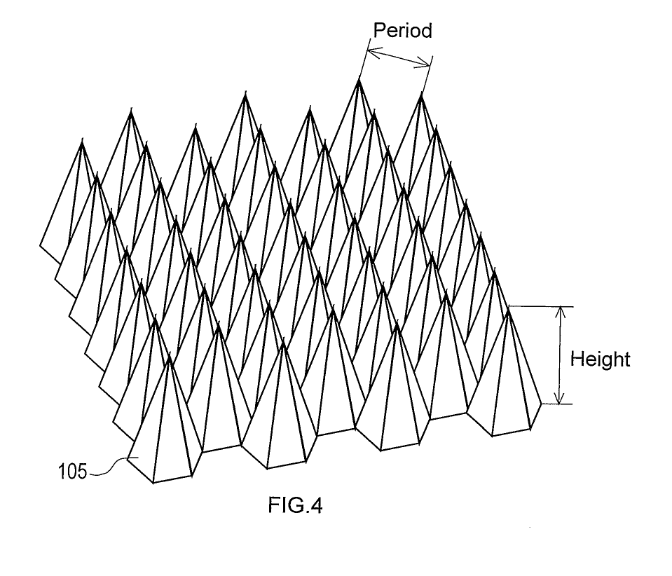

Moreover, in this embodiment, as the antireflection structure 102, an antireflection structure comprising structural elements having the shape of a cone is taken as an example and described; however, the antireflection structure is not necessary limited to this configuration. For example, the structural element may have the shape of a pyramid, such as a regular hexagonal pyramid 108 shown in FIG. 4 or a quadrangular pyramid. In addition, the shape of the structural element of the antireflection structure is not necessarily limited to a cone or a pyramid; the shape may be a cylinder or a prism, or a shape rounded at the tip. The antireflection structure 102 should only be formed at least at a period shorter than the wavelength of the light whose reflection should be reduced.

Furthermore, in this embodiment, as the antireflection structure 102, a structure comprising structural elements formed of convex portions having the shape of a cone is shown; however, the structure is not limited to this. For example, an antireflection structure wherein concave portions having the shape of a cone are formed in an array form in a flat face may also be formed.

### SECOND EMBODIMENT

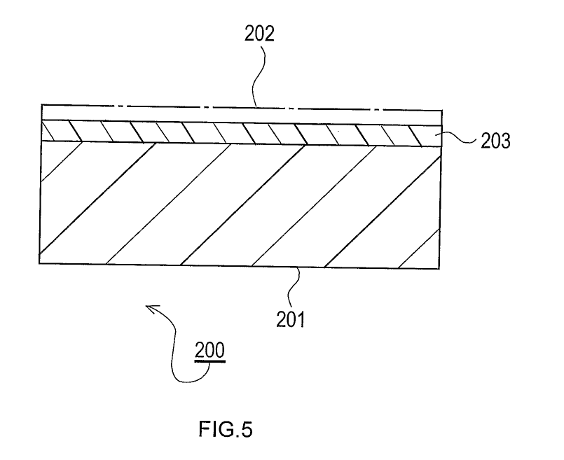

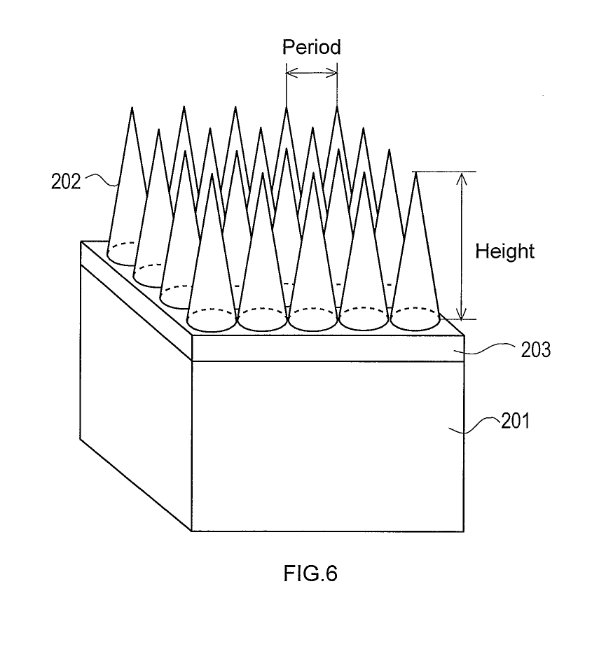

FIG. 5 is a schematic cross-sectional view showing a light-absorbing member in accordance with a second embodiment of the present invention, and FIG. 6 is a schematic perspective view showing the magnification thereof. As shown in FIGS. 5 and 6, the light-absorbing member 200 in accordance with this embodiment comprises a substrate 201, an antireflection structure 202, and a sheet member 203. When light whose reflection should be prevented enters as a luminous flux, the substrate 201 has a size enclosing the luminous flux and also has mechanical strength and a thickness required in structure. In addition, the substrate 201 is made of a material capable of absorbing light whose reflection should be reduced; for example, it is made of a black material when the light whose reflection should be prevented is visible light. The black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin.

The sheet member 203 is bonded to the surface of the substrate 201, and the antireflection structure 202 is formed on the surface of the sheet member. The sheet member 203 is made of acrylic resin having a thickness of 10 μm or more so that easy handling and sufficient mechanical strength are obtained. The difference in refractive index between the sheet member 203 and the substrate 201 is required to be 0.2 or less. By setting the difference in refractive index between the sheet member 203 and the substrate 201 at 0.2 or less, the reflection of light at the interface between the sheet member 203 and the substrate 201 can be suppressed to the extent that no problem is caused. In addition, the difference in refractive index between the sheet member 203 and the substrate 201 is preferably 0.1 or less. By setting the difference in refractive index between the sheet member 203 and the substrate 201 at 0.1 or less, the reflection of light at the interface between the sheet member 203 and the substrate 201 can be prevented further, and the generation of unnecessary light can be suppressed efficiently. At this time, the sheet member 203 is bonded to the substrate 201 by using, as an adhesive, ultraviolet cure resin or the like that cures when ultraviolet light is applied thereto. In this case, the layer of the adhesive is also assumed to be a component of the sheet member 203, and the refractive index of the adhesive is desired to satisfy the above-mentioned condition.

An example of a method for producing the sheet member 203 for use in the light-absorbing member 200 will be described. For example, a pattern is drawn on a quartz glass substrate or the like by an electronic beam drawing method or the like and subjected to dry etching or other processing, and a high-precision master mold precision-machined so as to have the same shape as that of the antireflection structure 202 is made beforehand. An acrylic resin material heated and softened is subjected to pressure molding using this master mold, whereby a mold for molding antireflection structures is formed of acrylic resin. At this time, the sheet member 203 is desired to have a thickness of 10 μm or more (the thickness of the sheet member 203 +0.15 μm) so that easy handling and sufficient mechanical strength are obtained.

As described above, the light-absorbing member 200 in accordance with this embodiment has an effect (improvement in light-absorbing efficiency) similar to that obtained in the case of the light-absorbing member 100 in accordance with the above-mentioned first embodiment, and a target structure can easily be formed into a light-absorbing member by simply bonding the sheet member 203.

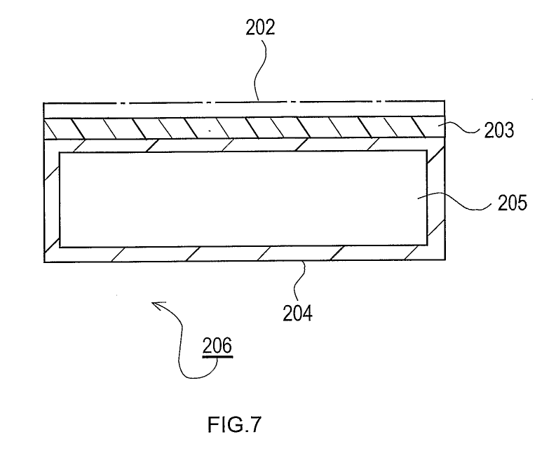

In addition, as in the case of the above-mentioned first embodiment, if the light-absorbing member 200 is used continuously for a long time at a place at which light arrives frequently, it is heated and may be degraded. In this case, such a problem can be solved by adopting a light-absorbing member 206 having a space 205, in which a refrigerant is sealed, inside the substrate 204 thereof as shown in FIG. 7. As the refrigerant, an antifreeze liquid consisting of polyethylene glycol and water, air, a mixture liquid of alcohol and water, etc. can be used.

In this embodiment, a transparent material, such as acrylic resin, is used as the material of the sheet member 203; however, the material is not necessarily limited to a transparent material, but a black material colored with dyes or pigments in black may also be used. Further improvement in light-absorbing efficiency can be attained by using a black material as the material of the sheet member 203. Furthermore, other than acrylic resin, polycarbonate resin, polyethylene terephthalate resin, etc. can also be used as a transparent material.

Also in this embodiment, as in the case of the above-mentioned first embodiment, an antireflection structure having cones with a height corresponding to the period or more is formed; however, light-absorbing efficiency can be raised further by forming an antireflection structure having cones with a height corresponding to three times the period or more.

In addition, in this embodiment, as in the case of the above-mentioned first embodiment, visible light is used as the light whose reflection should be reduced; however, other than visible light, ultraviolet light (the wavelength of ultraviolet spectrum: 70 nm to 400 nm), near-infrared light (the wavelength of near-infrared spectrum: 700 nm to 2 μm) and far-infrared light (the wavelength of far-infrared spectrum: 2 μm to 13 μm) can also be used; even in this case, the antireflection structure is formed at a period shorter than the respective wavelengths. Even in this case, the concave portion is desired to have a height corresponding to the period or more or three times the period or more.

Furthermore, in this embodiment, as in the case of the above-mentioned first embodiment, the substrate 201 made of a black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin; however, the substrate can also be obtained by including a pigment, such as carbon black.

Furthermore, in this embodiment, the sheet member 203 made of a black material can be obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin. Moreover, the sheet member 203 can also be obtained by including a pigment, such as carbon black.

Moreover, in this embodiment, as in the case of the above-mentioned first embodiment, as the antireflection structure 202, an antireflection structure comprising structural elements having the shape of a cone is taken as an example and described; however, the antireflection structure is not necessary limited to this configuration. For example, the structural element may have the shape of a pyramid, such as a regular hexagonal pyramid or a quadrangular pyramid. In addition, the shape of the structural element of the antireflection structure is not necessarily limited to a cone or a pyramid; the shape may be a cylinder or a prism, or a shape rounded at the tip. The antireflection structure 202 should only be formed at least at a period shorter than the wavelength of the light whose reflection should be reduced.

Furthermore, in this embodiment, as the antireflection structure 202, a structure comprising structural elements formed of convex portions having the shape of a cone is shown; however, the structure is not limited to this. For example, an antireflection structure wherein concave portions having the shape of a cone are formed in an array form in a flat face may also be formed.

### THIRD EMBODIMENT

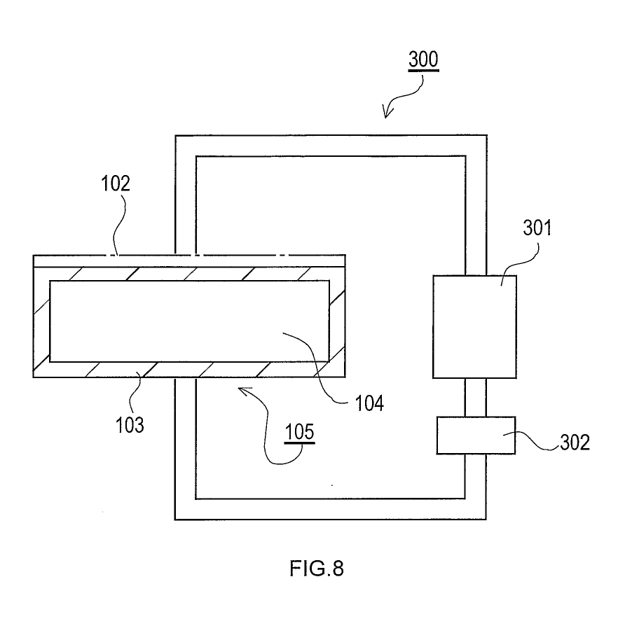

FIG. 8 is a schematic view showing a light-absorbing device in accordance with a third embodiment of the present invention. As shown in FIG. 8, the light-absorbing device 300 in accordance with the this embodiment comprises the light-absorbing member 105 in accordance with the modified example of the first embodiment, a pump 301 and a heat dissipater 302. The pump 301 transfers the refrigerant sealed in the space 104 inside the substrate 103 to the outside, allows the refrigerant to pass through the heat dissipater 302 and returns the refrigerant to the space 104. Although a radiator provided so as to be separate from the pump 301 is suitably used as the heat dissipater 302, a radiation fin integrally provided on the pump 301 may also be used as the heat dissipater 302.

With the above-mentioned configuration, the light-absorbing member 105 can be used while the refrigerant sealed in the space formed inside the substrate 103 is cooled down, whereby the light-absorbing member 105 can be prevented from being degraded.

Also in this embodiment, as in the case of the above-mentioned first embodiment, an antireflection structure having cones with a height corresponding to the period or more is formed; however, light-absorbing efficiency can be raised further by forming an antireflection structure having cones with a height corresponding to three times the period or more.

In addition, in this embodiment, as in the case of the above-mentioned first embodiment, visible light is used as the light whose reflection should be reduced; however, other than visible light, ultraviolet light (the wavelength of ultraviolet spectrum: 70 nm to 400 nm), near-infrared light (the wavelength of near-infrared spectrum: 700 nm to 2 μm) and far-infrared light (the wavelength of far-infrared spectrum: 2 μm to 13 μm) can also be used; even in this case, the antireflection structure is formed at a period shorter than the respective wavelengths. Even in this case, the concave portion is desired to have a height corresponding to the period or more or three times the period or more.

Furthermore, in this embodiment, as in the case of the above-mentioned first embodiment, the substrate 103 made of a black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin; however, the substrate can also be obtained by including a pigment, such as carbon black.

Furthermore, in this embodiment, as in the case of the above-mentioned first embodiment, the sheet member 301 made of a black material can be obtained by including a dye, such as a blackdye (for example, Plast Black 8950 or 8970 produced by Arimoto Chemical Co., Ltd.) obtained by mixing cyan, magenta, yellow and other coloring matters, into a base material, such as polycarbonate resin or acrylic resin. Moreover, the sheet member 301 can also be obtained by including a pigment, such as carbon black.

Moreover, in this embodiment, as in the case of the above-mentioned first embodiment, as the antireflection structure 102, an antireflection structure comprising structural elements having the shape of a cone is taken as an example and described; however, the antireflection structure is not necessary limited to this configuration. For example, the structural element may have the shape of a pyramid, such as a regular hexagonal pyramid or a quadrangular pyramid. In addition, the shape of the structural element of the antireflection structure is not necessarily limited to a cone or a pyramid; the shape may be a cylinder or a prism, or a shape rounded at the tip. The antireflection structure 102 should only be formed at least at a period shorter than the wavelength of the light whose reflection should be reduced.

Furthermore, in this embodiment, as the antireflection structure 102, a structure comprising structural elements formed of convex portions having the shape of a cone is shown; however, the structure is not limited to this. For example, an antireflection structure wherein concave portions having the shape of a cone are formed in an array form in a flat face may also be formed.

Furthermore, in the this embodiment, the configuration of the light-absorbing member 105 in accordance with the above-mentioned first embodiment, shown in FIG. 3, that is, a section obtained by excluding the pump 301 and the heat dissipater 302, is used as a light-absorbing member; however, the configuration is not necessarily limited to this configuration. For example, the configuration of the light-absorbing member 206 in accordance with the above-mentioned second embodiment, shown in FIG. 7, may also be used. In this case, other than a transparent material, such as acrylic resin, a black material colored with dyes or pigments in black can also be used as the material of the sheet member 203. In addition, other than acrylic resin, polycarbonate resin, polyethylene terephthalate resin, etc. can also be used as a transparent material.

In this embodiment, resin is used as the substrate 103; however, the material is not limited to resin, but a metallic member made of aluminum or the like can also be used. In this case, the surface of the metallic member may be coated with a black material obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin, acrylic resin, or coated with a light-absorbing material in which a pigment, such as carbon black, is mixed, instead of the black dye, and the microscopic antireflection structure formed at a period shorter than the wavelength of the light whose reflection should be prevented may be provided on the coated surface. Alternatively, the surface of the metallic member may be coated with black paint, and the sheet member 203 in accordance with the above-mentioned second embodiment may be bonded to the surface coated with the paint.

### FOURTH EMBODIMENT

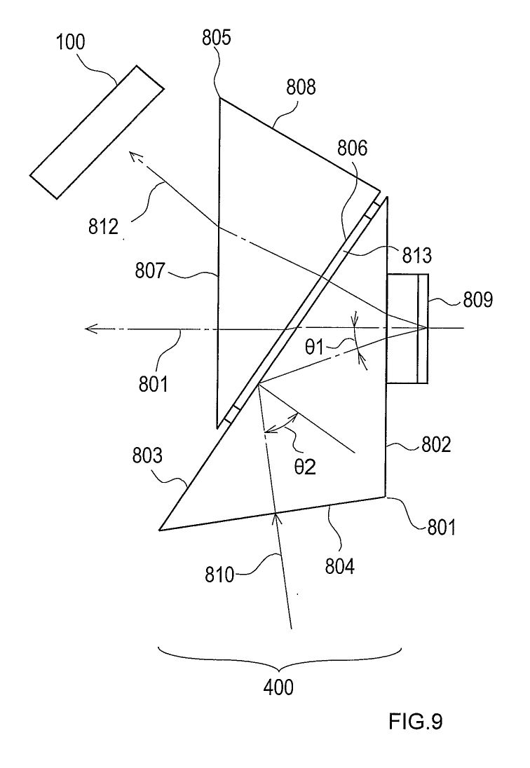

FIG. 9 is a schematic cross-sectional view showing an illumination prism device in accordance with a fourth embodiment of the present invention. As shown in FIG. 9, the illumination prism device 400 in accordance with this embodiment comprises a light valve 409, a first prism (rectangular prism) 401 and a second prism (rectangular prism) 405 provided sequentially from the side of the light valve 409, and the light-absorbing member 100 described in the first embodiment. In addition, an air layer 413 is provided between the first prism 401 and the second prism 405.

The first prism 401 has a first face 402 adjacent to the light valve 409, a second face 403 and a third face 404 on which light 410 falls, the air layer 413 being formed between the second face 403 and the second prism 405.

The second prism 405 has a first face 406, a second face 407 from which the reflected light from the light valve 409 goes out and which is nearly parallel to the first face 402 of the first prism 401, and a third face 408, the air layer 413 being formed between the first face 406 and the first prism 401.

The light valve 409 is a reflective spatial light modulator that controls the traveling direction of light in accordance with an image signal to form an optical image, and it is driven by a signal, not shown, corresponding to an image supplied from the outside.

In the above-mentioned configuration, after entering the third face 404 of the first prism 401 at a right angle, the illumination light 410 enters the second face 403 at an incident angle θ2, is totally reflected thereby, and enters the light valve 409 at an incident angle θ1. When the light valve 409 is in its ON state, reflected light 411 (ON light) from the light valve 409 goes out in a direction perpendicular to the second face 407 of the second prism 405. On the other hand, when the light valve 409 is in its OFF state, reflected light 412 (OFF light) from the light valve 409 goes out obliquely to the second face 407 of the second prism 405.

Near the second prism 405 and on the side of the second face 407, the light-absorbing member 100 described in the above-mentioned first embodiment is disposed in the direction of the reflected light 412 that goes out from the light valve 409 when the light valve 409 is in its OFF state. Hence, the unnecessary light generated when the light valve 409 is in its OFF state can be absorbed completely by the light-absorbing member 100.

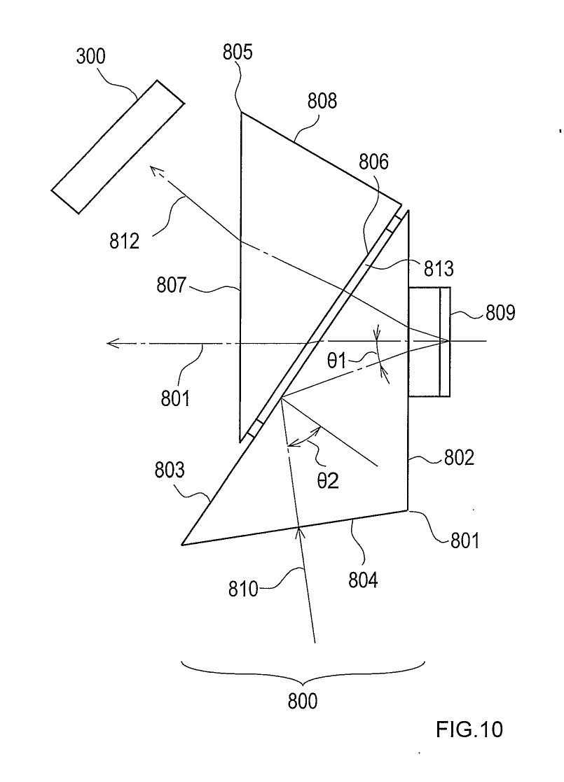

In FIG. 9, the light-absorbing member 100 described in the above-mentioned first embodiment is disposed near the second prism 405 and on the side of the second face 407; however, even if the light-absorbing device 300 described in the above-mentioned third embodiment is disposed as shown in FIG. 10, a similar effect is obtained. In addition, even if the light-absorbing member 105 described in the modified example in accordance with the first embodiment or the light-absorbing member 200 or 206 described in the second embodiment is disposed at the position of the light-absorbing member 100, a similar effect is obtained.

### FIFTH EMBODIMENT

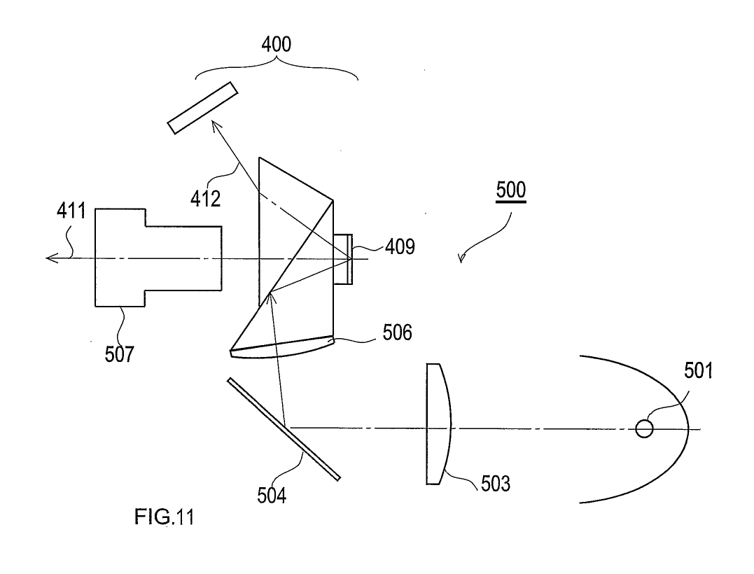

FIG. 11 is a schematic configurational view showing a projection display device in accordance with a fifth embodiment of the present invention. As shown in FIG. 11, the projection display device 500 in accordance with this embodiment comprises the illumination prism device 400 described in the above-mentioned fourth embodiment, a light source 501, a mirror 504 for bending the illumination light from the light source 501 toward the illumination prism device 400, and a projection lens 507 for projecting the light obtained by modulating the illumination light from the light source 501 using the light valve 409 (reflective spatial light modulator) of the illumination prism device 400. In addition, a condenser lens 503 is disposed between the light source 501 and the mirror 504, and a condenser lens 506 is installed on the third face 404 (see FIGS. 9 and 10) of the first prism 401 constituting the illumination prism device 400.

In the projection display device in accordance with this embodiment, the illumination prism device 400 described in the above-mentioned fourth embodiment is used as described above, whereby the unnecessary light generated when the light valve 409 is in its OFF state can be absorbed completely by the light-absorbing member 100. As a result, light components that may generate stray light are prevented, and a projection display device being excellent in contrast and high in image quality can be achieved.

In this embodiment, in the prism device 400, the light-absorbing member 100 described in the above-mentioned first embodiment is disposed; however, even if the light-absorbing device 300 described in the above-mentioned third embodiment is disposed, a similar effect is obtained. In addition, even if the light-absorbing member 105 described in the modified example in accordance with the first embodiment or the light-absorbing member 200 or 206 described in the second embodiment is disposed at the position of the light-absorbing member 100, a similar effect is obtained.

### SIXTH EMBODIMENT

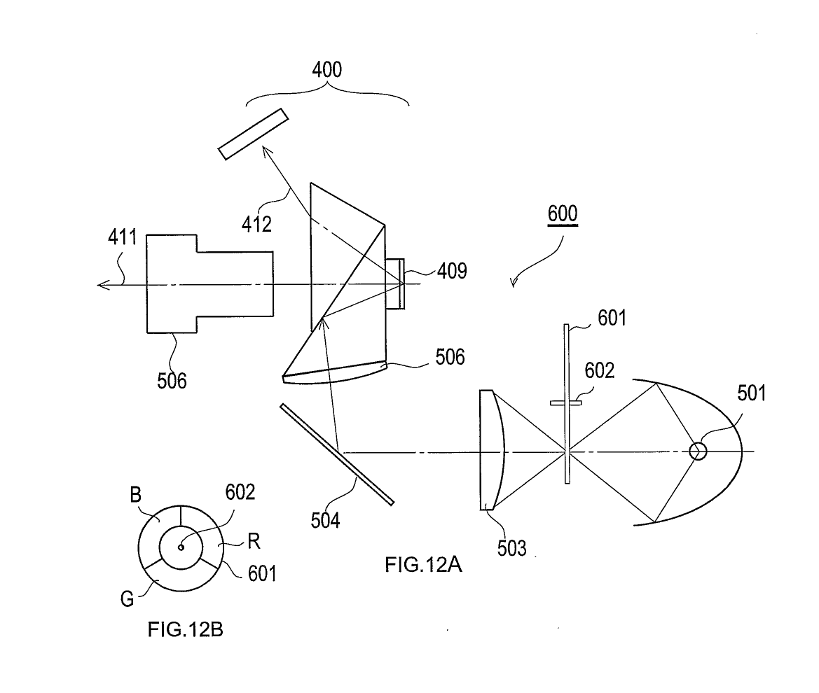

FIG. 12A is a schematic configurational view showing a projection display device in accordance with a sixth embodiment of the present invention. FIG. 12B is a elevation view showing a color wheel provided for a projection display device in accordance with a sixth embodiment of the present invention. The projection display device 600 in accordance with this embodiment differs from the projection display device 500 in accordance with the above-mentioned fifth embodiment in the following points. In other words, as shown in FIGS. 12A and 12B, in the projection display device 600 in accordance with this embodiment, a color wheel for limiting and separating the light from the light source 501 into three colors, blue, green and red, with respect to time, by rotating an RGB filter 601 around a support shaft 602 is disposed between the light source 501 and the condenser lens 503. Furthermore, the light valve 409 (reflective spatial light modulator) forms an optical image corresponding to the three colors, blue, green and red, obtained by the limiting and separation with respect to time, and extended projection can be carried out in full color. Furthermore, in the projection display device 600 in accordance with this embodiment, the illumination prism device 400 described in the above-mentioned fourth embodiment is used, whereby the unnecessary light generated when the light valve 409 is in its OFF state can be absorbed completely by the light-absorbing member 100. As a result, light components that may generate stray light are prevented, and a projection display device being excellent in contrast and high in image quality can be achieved.

In this embodiment, in the prism device 400, the light-absorbing member 100 described in the above-mentioned first embodiment is disposed; however, even if the light-absorbing device 300 described in the above-mentioned third embodiment is disposed, a similar effect is obtained. In addition, even if the light-absorbing member 105 described in the modified example in accordance with the first embodiment is disposed at the position of the light-absorbing member 100, a similar effect is obtained.

### SEVENTH EMBODIMENT

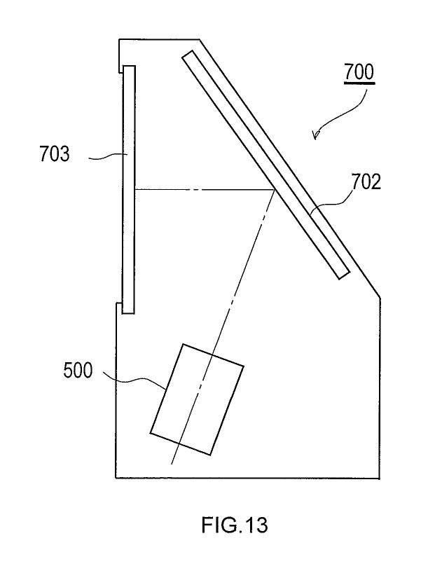

FIG. 13 is a schematic configurational view showing a rear projector in accordance with a seventh embodiment of the present invention. As shown in FIG. 13, the rear projector 700 in accordance with this embodiment comprises the projection display device 500 described in the above-mentioned fifth embodiment, a mirror 702 for bending the light projected from the projection lens 507 (see FIGS. 11 and 12) inside the projection display device 500, and a transmission screen 703 for transmitting, scattering and displaying the light bent by the mirror 702 as an image.

In the rear projector 700 in accordance with this embodiment, the image projected from the projection display device 500 is reflected by the mirror 702 and formed on the transmission screen 703. Furthermore, in the rear projector 700 in accordance with this embodiment, as the projection display device 500, the projection display device described in the above-mentioned fifth embodiment is used, whereby the unnecessary light generated when the light valve is in its OFF state can be absorbed completely by the light-absorbing member or the light-absorbing device. As a result, in the OFF light, light components that may generate stray light are prevented, and a rear projector being excellent in contrast and high in image quality can be achieved.

### EIGHTH EMBODIMENT

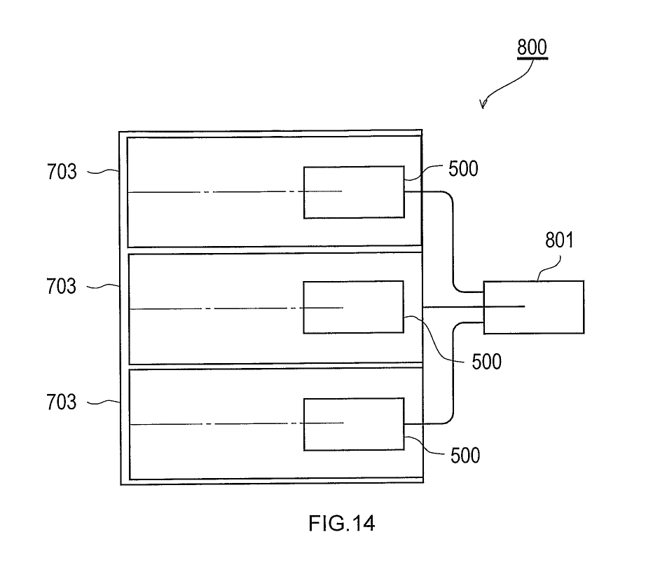

FIG. 14 is a schematic configurational view showing a multivision system in accordance with an eighth embodiment of the present invention. As shown in FIG. 14, the multivision system 800 in accordance with this embodiment comprises a plurality of the projection display devices 500 described in the above-mentioned fifth embodiment, a plurality of transmission screens 703 provided for the projection display devices 500 respectively corresponding thereto, and an image signal supplying means 801 for supplying image signals to the respective projection display devices 500.

The image signal supplying means 801 has a function of dividing one image signal into image signals and supplying the image signals divided and being different to the respective projection display devices. This function is achieved by an image dividing circuit installed in the image signal supplying means 801.

In the multivision system in accordance with this embodiment, an image signal is processed and divided by the image dividing circuit and supplied to the plurality of the projection display devices 500. The image projected from each projection display device 500 is formed on each transmission screen 703. Furthermore, in the multivision system in accordance with this embodiment, as the projection display device 500, the projection display device described in the above-mentioned fifth embodiment is used, whereby the unnecessary light generated when the light valve is in its OFF state can be absorbed completely by the light-absorbing member or the light-absorbing device. As a result, in the OFF light, light components that may generate stray light are prevented, and a multivision system being excellent in contrast and high in image quality can be achieved. Substrate 905

### NINTH EMBODIMENT

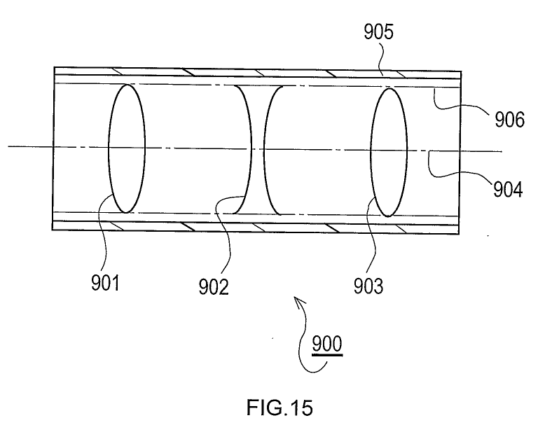

FIG. 15 is a schematic cross-sectional view showing a lens barrel in accordance with a ninth embodiment of the present invention. As shown in FIG. 15, the lens barrel 900 in accordance with this embodiment comprises a substrate 905, an antireflection structure 906, a lens 901, a lens 902 and a lens 903. The substrate 905 has a cylindrical shape and is made of a black material. The black material of the substrate 905 is a material obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin, or a light-absorbing material in which a pigment, such as carbon black, is mixed, instead of the black dye.

In the antireflection structure 906, a cone of 0.15 μm in height is used as a structural element, and these cones are disposed on the surface of the substrate 905 in an array form at a period of 0.15 μm. The period between the cones herein corresponds to a period shorter than the wavelength of the visible spectrum (400 nm to 700 nm). In addition, the height of these cones corresponds to the period or more. Since the antireflection structure 906 has the above-mentioned configuration, even if light having a wavelength of the visible spectrum or longer enters, the light is not reflected but can be absorbed by the substrate 905 substantially completely.

The lens 901, the lens 902 and the lens 903 are all disposed coaxially along the optical axis 904.

In the above-mentioned configuration, stray light generated by a luminous flux entering from the left side of the lens barrel 900 and having an angle not smaller than the coverage view angle and by reflection on the surfaces of the above-mentioned lenses enters the internal face of the lens barrel 900 and becomes unnecessary light. The incident luminous flux is efficiently absorbed by the microscopic antireflection structure 906 provided on the internal surface of the substrate 905, whereby ghost and flare are prevented from being generated. Hence, for example, when the lens barrel 900 is used for the barrel of the image-taking optical system of a digital still camera, a camcorder, etc. and for the barrel of the projection lens of a projection display device, the formation of an optical image being excellent in contrast can be achieved.

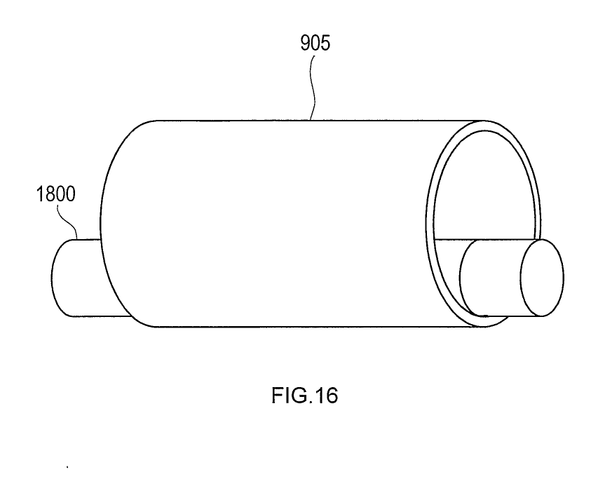

The lens barrel 900 in accordance with this embodiment can be produced as described below, for example. That is to say, it can be produced by transferring an uneven pattern corresponding to the antireflection structure formed on the surface at a microscopic period smaller than the shortest wavelength among the wavelengths of light being used in the lens barrel on the internal face of the substrate 905 of the lens barrel 900 using a hot press. More specifically, as shown in FIG. 16, it can be produced by simultaneously heating, pressing and rotating a cylindrical mold 907, having a microscopic antireflection structure at a period smaller than the shortest wavelength among the wavelengths of image-taking light on the external circumferential face, on the internal face of the substrate 905 of the lens barrel 900, and by transferring the uneven pattern on the external circumferential face of the cylindrical mold 907 to the internal face of the substrate 905 of the lens barrel 900.

In this embodiment, an antireflection structure having cones with a height corresponding to the period or more is formed; however, light-absorbing efficiency can be raised further by forming an antireflection structure having cones with a height corresponding to three times the period or more.

In addition, in this embodiment, visible light is used as the light whose reflection should be reduced; however, other than visible light, ultraviolet light (the wavelength of ultraviolet spectrum: 70 nm to 400 nm), near-infrared light (the wavelength of near-infrared spectrum: 700 nm to 2 μm) and far-infrared light (the wavelength of far-infrared spectrum: 2 μm to 13 μm) can also be used in accordance with usage; even in this case, the antireflection structure is formed at a period smaller than the respective wavelengths. Even in this case, the concave portion is desired to have a height corresponding to the period or more or three times the period or more.

Furthermore, in this embodiment, the substrate 905 made of a black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin; however, the substrate can also be obtained by including a pigment, such as carbon black.

Moreover, in this embodiment, as the antireflection structure 906, an antireflection structure comprising structural elements having the shape of a cone is taken as an example and described; however, the antireflection structure is not necessary limited to this configuration. For example, the structural element may have the shape of a pyramid, such as the regular hexagonal pyramid 108 shown in FIG. 4 or a quadrangular pyramid. In addition, the shape of the structural element of the antireflection structure is not necessarily limited to a cone or a pyramid; the shape may be a cylinder or a prism, or a shape rounded at the tip. The antireflection structure 906 should only be formed at least at a period smaller than the wavelength of the light whose reflection should be reduced.

Furthermore, in this embodiment, as the antireflection structure 906, a structure comprising structural elements formed of convex portions having the shape of a cone is shown; however, the structure is not limited to this. For example, an antireflection structure wherein concave portions having the shape of a cone are formed in an array form in a flat face may also be formed.

### TENTH EMBODIMENT

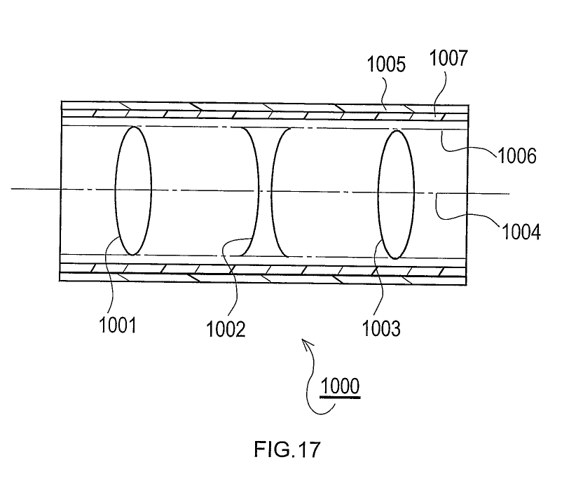

FIG. 17 is a schematic cross-sectional view showing a lens barrel in accordance with a tenth embodiment of the present invention. As shown in FIG. 17, the lens barrel 1000 in accordance with this embodiment comprises a substrate 1005, an antireflection structure 1006, a sheet member 1007, a lens 1001, a lens 1002 and a lens 1003. When light whose reflection should be prevented enters as a luminous flux, the substrate 1005 has a size enclosing the luminous flux and also has mechanical strength and a thickness required in structure. In addition, the substrate 1005 is made of a material capable of absorbing light whose reflection should be reduced; for example, it is made of a black material when the light whose reflection should be prevented is visible light. The black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin.

The sheet member 1007 is bonded to the surface of the substrate 1005, and the antireflection structure 1006 is formed on the surface of the sheet member. The sheet member 1007 is made of acrylic resin having a thickness of 10 μm or more so that easy handling and sufficient mechanical strength are obtained. The difference in refractive index between the sheet member 1007 and the substrate 1005 is required to be 0.2 or less. By setting the difference in refractive index between the sheet member 1007 and the substrate 1005 at 0.2 or less, the reflection of light at the interface between the sheet member 1007 and the substrate 1005 can be suppressed to the extent that no problem is caused. In addition, the difference in refractive index between the sheet member 1007 and the substrate 1005 is preferably 0.1 or less. By setting the difference in refractive index between the sheet member 1007 and the substrate 1005 at 0.1 or less, the reflection of light at the interface between the sheet member 1007 and the substrate 1005 can be prevented further, and the generation of unnecessary light can be suppressed efficiently. At this time, the sheet member 1007 is bonded to the substrate 1005 by using, as an adhesive, ultraviolet cure resin or the like that cures when ultraviolet light is applied thereto. In this case, the layer of the adhesive is also assumed to be a component of the sheet member 1007, and the refractive index of the adhesive is desired to satisfy the above-mentioned condition.

An example of a method for producing the sheet member 1007 will be described. For example, a pattern is drawn on a quartz glass substrate or the like by an electronic beam drawing method or the like and subjected to dry etching or other processing, and a high-precision master mold precision-machined so as to have the same shape as that of the antireflection structure 1006 is made beforehand. An acrylic resin material heated and softened is subjected to pressure molding using this master mold, whereby a mold for molding antireflection structures is formed of acrylic resin. At this time, the sheet member 1007 is desired to have a thickness of 10 μm or more (the thickness of the sheet member 1007 +0.15 μm) so that easy handling and sufficient mechanical strength are obtained.

In the above-mentioned configuration, stray light generated by a luminous flux entering from the left side of the lens barrel 1000 and having an angle not smaller than the coverage view angle and by reflection on the surfaces of the above-mentioned lenses enters the internal face of the lens barrel 1000 and becomes unnecessary light. The incident luminous flux is efficiently absorbed by the microscopic antireflection structure 1006 provided on the internal surface of the substrate 1005, whereby ghost and flare are prevented from being generated. Hence, for example, when the lens barrel 1000 isused for the barrel of the image-taking optical system of a digital still camera, a camcorder, etc. and for the barrel of the projection lens of a projection display device, the formation of an optical image being excellent in contrast can be achieved.

As described above, the lens barrel in accordance with this embodiment has an effect (improvement in light-absorbing efficiency) similar to that obtained in the case of the lens barrel 900 in accordance with the above-mentioned ninth embodiment, and an antireflection structure can easily be formed on the internal face of a target barrel by simply bonding the sheet member 1007.

In this embodiment, a transparent material, such as acrylic resin, is used as the material of the sheet member 1007; however, the material is not necessarily limited to a transparent material, but a black material colored with dyes or pigments in black may also be used. Further improvement in light-absorbing efficiency can be attained by using a black material as the material of the sheet member 1007. Furthermore, other than acrylic resin, polycarbonate resin, polyethylene terephthalate resin, etc. can also be used as a transparent material.

The sheet member 1007 made of a black material can be obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin. Moreover, the sheet member 1007 can also be obtained by including a pigment, such as carbon black.

Also in this embodiment, as in the case of the above-mentioned first embodiment, an antireflection structure having cones with a height corresponding to the period or more is formed; however, light-absorbing efficiency can be raised further by forming an antireflection structure having cones with a height corresponding to three times the period or more.

In addition, in this embodiment, as in the case of the above-mentioned first embodiment, visible light is used as the light whose reflection should be reduced; however, other than visible light, ultraviolet light (the wavelength of ultraviolet spectrum: 70 nm to 400 nm), near-infrared light (the wavelength of near-infrared spectrum: 700 nm to 2 μm) and far-infrared light (the wavelength of far-infrared spectrum: 2 μm to 13 μm) can also be used; even in this case, the antireflection structure is formed at a period smaller than the respective wavelengths. Even in this case, the concave portion is desired to have a height corresponding to the period or more or three times the period or more.

Furthermore, in this embodiment, as in the case of the above-mentioned first embodiment, the substrate 1005 made of a black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin; however, the substrate can also be obtained by including a pigment, such as carbon black.

Moreover, in this embodiment, as in the case of the above-mentioned first embodiment, as the antireflection structure 1006, an antireflection structure comprising structural elements having the shape of a cone is taken as an example and described; however, the antireflection structure is not necessary limited to this configuration. For example, the structural element may have the shape of a pyramid, such as a regular hexagonal pyramid or a quadrangular pyramid. In addition, the shape of the structural element of the antireflection structure is not necessarily limited to a cone or a pyramid; the shape may be a cylinder or a prism, or a shape rounded at the tip. The antireflection structure 1006 should only be formed at least at a period smaller than the wavelength of the light whose reflection should be reduced.

Furthermore, in this embodiment, as the antireflection structure 1006, a structure comprising structural elements formed of convex portions having the shape of a cone is shown; however, the structure is not limited to this. For example, an antireflection structure wherein concave portions having the shape of a cone are formed in an array form in a flat face may also be formed.

### ELEVENTH EMBODIMENT

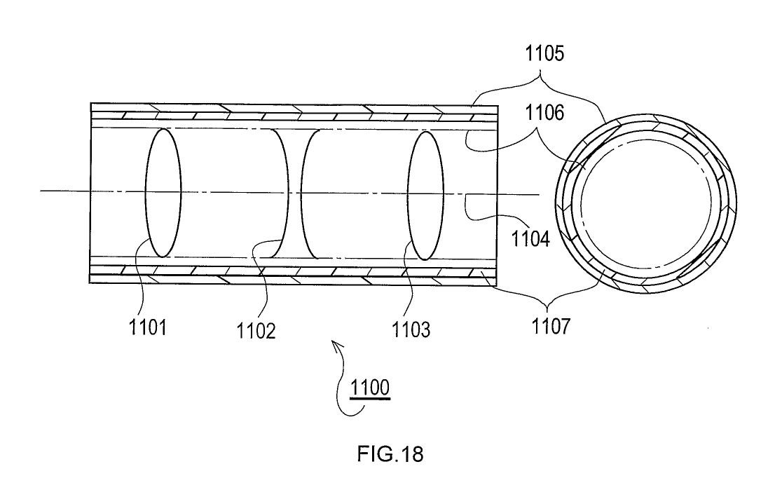

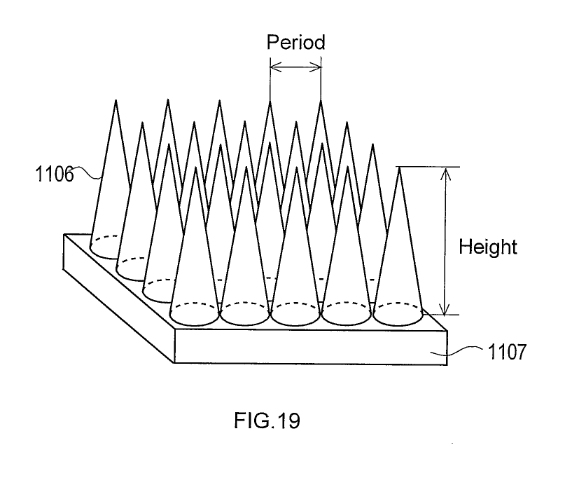

FIG. 18 is a schematic cross-sectional view showing a lens barrel in accordance with an eleventh embodiment of the present invention. FIG. 19 is a magnified schematic perspective view showing a sheet to be inserted on the internal face side of the lens barrel in accordance with the eleventh embodiment of the present invention. As shown in FIG. 18, the lens barrel 1100 in accordance with this embodiment is provided with a sheet member 1107 made of a black material, having amicroscopic antireflection structure 1106 formed at a period smaller than the wavelength of the light whose reflection should be prevented on the surface thereof, and inserted on the internal face side of a substrate 1105 serving as the main body of the lens barrel.

The sheet member 1107 has a thickness of 10 μm or more so that easy handling and sufficient mechanical strength are obtained. On the surface of the sheet member 1107, an antireflection structure comprising structural elements having the shape of a cone having a height of 0.15 μm and arranged at a period of 0.15 μm is formed as the microscopic antireflection structure 1106 (see FIG. 19).

An example of a method for producing the sheet member 1107 will be described. For example, a pattern is drawn on a quartz glass substrate or the like by an electronic beam drawing method or the like and subjected to dry etching or other processing, and a high-precision master mold precision-machined so as to have the same shape as that of the antireflection structure 1106 is made beforehand. An acrylic resin material heated and softened is subjected to pressure molding using this master mold, whereby a mold for molding antireflection structures is formed of acrylic resin. At this time, the sheet member 1107 is desired to have a thickness of 10 μm or more (the thickness of the sheet member 1107 +0.15 μm) so that easy handling and sufficient mechanical strength are obtained.

As described above, the lens barrel 1100 in accordance with this embodiment is configured by cutting the sheet member 1107 having the microscopic antireflection structure 1106 into an appropriate size and by inserting the sheet member on the internal face side of the substrate 1105 serving as the main body of the lens barrel, thereby having an effect similar to that of the lens barrels 900 and 1000 in accordance with the above-mentioned ninth and tenth embodiments, and being capable of giving a light-absorbing property to the internal face of a target lens barrel more easily by simply inserting the sheet.

As shown in FIG. 18, inside the lens barrel 1100 configured as described above, the lens 901, the lens 902 and the lens 903 are disposed coaxially along the optical axis 904. Stray light generated by a luminous flux entering from the left side of the lens barrel 1100 and having an angle not smaller than the coverage view angle and by reflection on the surfaces of the above-mentioned lenses enters the internal face of the lens barrel 1100; however, the incident luminous flux is efficiently absorbed by the microscopic antireflection structure 1106 formed on the surface of the sheet member 1107 inserted inside the lens barrel 1100.

In this embodiment, a transparent material, such as acrylic resin, is used as the material of the sheet member 1107; however, the material is not necessarily limited to a transparent material, but a black material colored with dyes or pigments in black may also be used. Further improvement in light-absorbing efficiency can be attained by using a black material as the material of the sheet member 1107. Furthermore, other than acrylic resin, polycarbonate resin, polyethylene terephthalate resin, etc. can also be used as a transparent material.

Also in this embodiment, as in the case of the above-mentioned first embodiment, an antireflection structure having cones with a height corresponding to the period or more is formed; however, light-absorbing efficiency can be raised further by forming an antireflection structure having cones with a height corresponding to three times the period or more.

In addition, in this embodiment, as in the case of the above-mentioned first embodiment, visible light is used as the light whose reflection should be reduced; however, other than visible light, ultraviolet light (the wavelength of ultraviolet spectrum: 70 nm to 400 nm), near-infrared light (the wavelength of near-infrared spectrum: 700 nm to 2 μm) and far-infrared light (the wavelength of far-infrared spectrum: 2 μm to 13 μm) can also be used; even in this case, the antireflection structure is formed at a period smaller than the respective wavelengths. Even in this case, the concave portion is desired to have a height corresponding to the period or more or three times the period or more.

Furthermore, in this embodiment, as in the case of the above-mentioned first embodiment, the substrate 1105 made of a black material is obtained by including a dye, such as a black dye (for example, Plast Black 8950 or 8970 produced by Arimoto Chemical Co., Ltd.) obtained by mixing cyan, magenta, yellow and other coloring matters, into a base material, such as polycarbonate resin or acrylic resin; however, the substrate can also be obtained by including a pigment, such as carbon black.

Moreover, in this embodiment, as in the case of the above-mentioned first embodiment, as the antireflection structure 1106, an antireflection structure comprising structural elements having the shape of a cone is taken as an example and described; however, the antireflection structure is not necessary limited to this configuration. For example, the structural element may have the shape of a pyramid, such as a regular hexagonal pyramid or a quadrangular pyramid. In addition, the shape of the structural element of the antireflection structure is not necessarily limited to a cone or a pyramid; the shape may be a cylinder or a prism, or a shape rounded at the tip. The antireflection structure 1106 should only be formed at least at a period smaller than the wavelength of the light whose reflection should be reduced.

Furthermore, in this embodiment, as the antireflection structure 1106, a structure comprising structural elements formed of convex portions having the shape of a cone is shown; however, the structure is not limited to this. For example, an antireflection structure wherein concave portions having the shape of a cone are formed in an array form in a flat face may also be formed.

### INDUSTRIAL APPLICABILITY

The light-absorbing member in accordance with the present invention is applicable to all the optical apparatuses requiring elimination of unnecessary light, for example, projection display devices, such as front projectors and rear projectors; multivision systems provided with a plurality of such projection display devices; image-taking devices, such as digital still cameras and camcorders; optical pickup devices; optical fiber communication systems; etc.

1. A light-absorbing member comprising:
a substrate made of a material capable of absorbing light of which reflection is to be prevented, and
an antireflective structure including structural elements, the structural elements forming an array with a period shorter than the wavelength of the light.

2. A light-absorbing member in accordance with claim 1, wherein the antireflection structure is formed as part of the substrate.

3. A light-absorbing member in accordance with claim 1, wherein the antireflection structure is formed on a sheet member bonded to the substrate.

4. A light-absorbing member in accordance with claim 3, wherein the sheet member is made of a material capable of transmitting the light.

5. A light-absorbing member in accordance with claim 3, wherein the sheet member is made of a material capable of absorbing the light.

6. A light-absorbing member in accordance with claim 3, wherein a difference in refractive index between the sheet member and the substrate is 0.2 or less.

7. A light-absorbing member in accordance with claim 3, wherein a difference in refractive index between the sheet member and the substrate is 0.1 or less.

8. A light-absorbing member in accordance with claim 1, wherein the substrate has a space in which a refrigerant is sealed.

9. A light-absorbing member in accordance with claim 1, wherein the structural element has a shape with a height corresponding to the period or more.

10. A light-absorbing member in accordance with claim 9, wherein the structural element has a shape with a height corresponding to three times the period or more.

11. A light-absorbing member in accordance with claim 1, wherein the bottom-face shape of the structural element is a shape selected from the group consisting of a nearly circular shape, a nearly rectangular shape and a nearly regular hexagonal shape.

12. A light-absorbing member in accordance with claim 1, wherein the substrate is made of a material including a dye.

13. A light-absorbing member in accordance with claim 1, wherein the substrate is made of a material including a pigment.

14. A light-absorbing member in accordance with claim 1, wherein the light is selected from the group consisting of ultraviolet light, visible light, near-infrared light and far-infrared light.
